(19) United States
(12) Patent Application Publication
(10) Pub. No.: US 2026/0148881 A1
(43) Pub. Date: May 28, 2026

(54) ELECTRICAL FEEDTHROUGH

(71) Applicant: Schott AG, Mainz (DE)

(72) Inventor: Helmut Hartl, Wien (AT)

(73) Assignee: Schott AG, Mainz (DE)

(21) Appl. No.: 19/400,511

(22) Filed: Nov. 25, 2025

(30) Foreign Application Priority Data
Nov. 28, 2024 (DE) 10 2024 135 169.1

(51) Int. Cl. H01B 17/30; H01G 11/78; H01M 50/191; H01M 50/533; H01M 50/534

(52) U.S. Cl. CPC H01B 17/303; H01G 11/78; H01M 50/191; H01M 50/533; H01M 50/534

(57) ABSTRACT

An electrical feedthrough includes: a fixing material; a main body including an opening; and a connecting pin, which is passed through the opening in the main body and which is held in place by the fixing material which seals the opening, the fixing material being a glass material, glass-ceramic material, or a ceramic, the connecting pin including or consisting of a core, the core directly adjoining the fixing material and including a copper material, the copper material in an annealed state after forming the electrical feedthrough having a 0.2% yield strength of at least 150 N/mm².

### CROSS REFERENCE TO RELATED APPLICATIONS

This claims priority to German patent application no. 10 2024 135 169.1, filed Nov. 28, 2024, which is incorporated herein by reference.

### BACKGROUND OF THE INVENTION

### 1. Field of the Invention

The present invention relates to electrical feedthroughs.

### 2. Description of the Related Art

Housings for electrical or electronic components generally require a multitude of electrical feedthroughs in order to enable electrical connections from the outside into the interior of the housing. The electrical feedthroughs must be liquid-tight or even hermetically sealed in order to protect the components in the housing from the environment and/or in order to keep gases or liquids in the interior of the housing. In order to obtain such liquid-tight or hermetic feedthroughs for an electrical conductor positioned in an opening of a main body, it is possible to use metal-fixing material feedthroughs. The main body may be a housing or part of a housing. A fixing material, for example a glass material, is used here to seal the opening and to hold the conductor in the opening. The fixing material also ensures electrical insulation between the conductor and the main body.

Such electrical feedthroughs are used, for example, in housings for electrical energy storage devices such as batteries or capacitors or in electrical feedthroughs for electrically driven compressors (electric compressors). Especially in applications where high electrical currents flow through the electrical feedthrough, materials with high electrical conductivity are optional for the connecting pin. Copper and many copper alloys have high electrical conductivity.

WO 2018/114392 A2 discloses an electrical feedthrough with a main made of a lightweight metal such as aluminium. A connecting pin that passes through an opening in the main body may be made of copper or a copper alloy and is held in the opening by a glass or glass-ceramic material.

However, in the case of the prior art known electrical feedthroughs with a connecting pin made of copper or of standard copper alloys, the problem occurs that the electrical feedthroughs can become leaky when electrical contacts are bonded to the connecting pin by welding or soldering.

What is needed in the art is an electrical feedthrough which remains sealed after welding or soldering of the connecting pin.

### SUMMARY OF THE INVENTION

The present invention relates to an electrical feedthrough including a main body with a through opening and a connecting pin positioned in the through opening, which is held in place in the through opening in an electrically insulating manner by way of a fixing material. A further aspect of the invention relates to an electrical energy storage device, an electrical connector and an electrically driven compressor, including at least one such feedthrough. The present invention provides an electrical feedthrough including a main body having an opening and a connecting pin, wherein the connecting pin is passed through the opening in the main body and is held in place by a fixing material which seals the opening, wherein the fixing material is a glass material, glass-ceramic material or a ceramic.

It is additionally the case that the connecting pin has or consists of a core, wherein the core directly adjoins the fixing material and consists of a copper material, wherein the copper material in an annealed state after the forming of the electrical feedthrough has a 0.2% yield strength of at least 150 N/mm², optionally of at least 200 N/mm², optionally at least 300 N/mm². Optional copper materials have a 0.2% yield strength of up to 500 N/mm² or even up to 600 N/mm².

What is meant here by a copper material is in particular a material consisting predominantly of copper, in particular including more than 50% by weight of copper, optionally more than 75% by weight, optionally more than 85% by weight of copper.

In electrical feedthroughs with a connecting pin made of copper or standard copper alloys, the problem occurs that the properties of the copper or copper alloy change after a thermal treatment as required in the forming of a metal-fixing material feedthrough with a glass material or a glass-ceramic material. In the case of standard copper alloys that have a sufficient 0.2% yield strength of more than 150 N/mm² before heating, this drops to a value below 150 N/mm² after the heat treatment for forming the metal-fixing material feedthrough.

The 0.2% yield strength is the (uniaxial) mechanical stress at which the permanent elongation after removal of load is exactly 0.2%, based on the starting length of a sample. The 0.2% yield strength is measured by known methods. The 0.2% yield strength is easy to determine by a tensile test. Such a tensile test is, for example, the tensile test according to ISO 6892-1:2020-06, with which the Rp 0.2 yield strength is determined. The tensile test on metal according to ISO 6892 is typically conducted on a universal tester/tensile tester.

A 0.2% yield strength after annealing or thermal treatment for forming the electrical feedthrough below a value of 150 N/mm² is problematic, since materials with a low 0.2% yield strength can easily be plastically deformed. However, plastic deformation of the connecting pin after the electrical feedthrough has been formed can result in leaking of the electrical feedthrough. Such plastic deformation has been observed in known electrical feedthroughs with a connecting pin made of copper or standard copper alloys, especially when the electrical feedthrough has been subjected to uneven heating. Such uneven heating occurs especially when electrical connectors such as terminal lugs and conductors are mounted on the connecting pin by welding or soldering. The welding results in significant heating of the connecting pin, while the glass or glass-ceramic material has poor heat conductivity and hence remains at low temperature. The material of the connecting pin expands owing to heating, while the remaining components of the electrical feedthrough are barely heated and largely retain their dimensions. The fixing material surrounding the connecting pin counteracts the expansion of the connecting pin and applies corresponding compressive forces to the connecting pin. If a deformation caused by the compressive forces reaches the plastic region, the connecting pin will permanently change shape. After cooling, the connecting pin will contract again, and cracks will now occur between the fixing material and the connecting pin owing to the permanent plastic changes in shape. This causes the electrical feedthrough to leak.

In the case that the copper material is chosen in accordance with the present invention for the connecting pin such that it has a 0.2% yield strength of at least 150 N/mm² even after the heat treatment for formation of the electrical feedthrough, deformation that occurs in an uneven heating operation, for example in the welding of an electrical contact, is in the elastic region and hence not permanent. After the connecting pin has cooled down, it reassumes its original dimensions, such that the feedthrough according to the invention remains sealed.

The metal-fixing material feedthrough formed is optionally hermetically sealed, where a feedthrough with a He leakage rate of less than 1·10⁻⁷ mbar l/s, optionally less than 1·10⁻⁸ mbar l/s, at a pressure differential of 1 bar is considered to be hermetically sealed. The feedthrough is in particular hermetically sealed even after the connecting pin has been heated once or more than once to a temperature above 500° C., optionally above 550° C., optionally above 600° C.

The copper material is optionally a dispersion-hardened copper material, in particular an OSD (oxide dispersion strengthened) copper material. Such OSD materials feature high strength, even at high temperatures, and good corrosion resistance. Because of a fine distribution of oxides it is not possible for the OSD material to diffuse even at very high temperatures, which also prevents grain boundaries from migrating to thermodynamically lower-energy states. These properties are based on a homogeneous distribution of oxidic dispersoids in the matrix, which are typically only a few nanometres in size.

In particular, no recrystallization occurs in these dispersion-hardened copper materials at temperatures of up to 900° C., i.e. close to the melting point of copper (1083° C.). Such recrystallization occurs in copper or standard copper alloys at least over and above 550° C. and leads to a loss of strength and hence to a decrease in the 0.2% yield point.

It is optional that the copper material contains at least 95% by weight, optionally at least 98% by weight, optionally at least 99% by weight, of copper and additionally contains at least 0.1% by weight, optionally at least 0.5% by weight, especially optionally at least 0.6% by weight, of Al₂O₃ and/or at least 0.03% by weight of boron. The proportion of Al₂O₃ is optionally not more than 2% by weight.

Further optional copper materials are copper alloys with a 0.2% yield strength after sealing of at least 150 N/mm². Optionally, the copper alloy is selected from Cu—Al₂O₃, CuBe, in particular CuBe2, CuCr, in particular CuCr1Zr, CuCoNiBe, in particular CuCo1NiBe, CuZr, CuNiSi, in particular CuNi2Si, and CuNiSiCr, in particular CuNi2SiCr.

The main body of the electrical feedthrough may take the form of a housing or part of a housing. The housing may in particular be a housing for an electrical energy storage device such as a battery or a capacitor, or a housing for an electrically driven compressor.

The material of the main body is a metal material. It is optional that a metal material chosen has a coefficient of thermal expansion equal to or greater than the coefficient of thermal expansion of the fixing material and/or the copper material.

The material of the main body is optionally selected from lightweight metal, lightweight metal alloy, AlSiC, steel, in particular ferritic, austenitic or duplex steel, stainless steel, special steel, tool steel. The lightweight metal or lightweight metal alloy may advantageously be aluminium, aluminium alloy, titanium, titanium alloy, magnesium or magnesium alloy. The material of the main body optionally is selected from aluminium or aluminium alloy or AlSiC. AlSiC has a matrix of SiC infiltrated with Al (aluminium also being known as aluminum).

In the context of the disclosure, lightweight metals mean metals having a density of less than 5.0 kg/dm³. In particular, the density of the lightweight metals is in the range of 1.0 kg/dm³ to 3.0 kg/dm³.

The fixing material is selected from a glass material or a glass-ceramic material.

Optional glasses include industrial glasses, in particular oxide glasses, which are optionally chemically resistant to customary materials in association with electrical energy storage devices.

In the case of an industrial glass, the fixing material is, for example, an aluminium phosphate glass including Al₂O₃ and P₂O₅, an aluminium borate glass including Al₂O₃ and B₂O₃, or a bismuth glass including, for example, Bi₂O₃ as glass former. Alternatively, glasses that include lead oxide as glass former, in particular glasses composed of the PbO—B₂O₃ system, or vanadium-containing glasses may be used as fixing material.

Examples of suitable glasses include phosphate glasses. A suitable phosphate glass that can be fused to the metals of the main body and the connecting pin at comparatively low temperatures of 500° C. to 650° C. is known from WO 2012/110247 A1, for example.

For the producing of the electrical feedthrough, the fixing material or a precursor material can be provided in the form of a shaped body. For example, the shaped body may take the form of a hollow cylinder. The electrical feedthrough is formed by inserting the connecting pin into the interior of this hollow cylinder and inserting the latter in turn into an opening in a main body. The connecting pin is inserted into the interior of the hollow cylinder such that the transition from core to cover material is outside the fixing material. The fixing material is connected to the wall of the opening and the wall of the connecting pin by way of a thermal treatment. In the case of a glass or a glass ceramic, the fixing material is fused onto the metal materials of the main body and the connecting pin. The bonding is effected at a temperature above 500° C., optionally at a temperature above 550° C., optionally above 600° C., with the temperature being maintained for a period of at least 10 minutes, optionally at least 15 minutes.

Accordingly, the copper material of the electrical feedthrough has been annealed by the thermal treatment, said annealing likewise being effected at a temperature above 500° C., optionally of 550° C., optionally above 600° C., for a period of at least 10 minutes, optionally at least 15 minutes.

The main body, the at least one conductor and the fixing material optionally form a metal-fixing material feedthrough in the form of a compression seal. Accordingly, a chosen first coefficient of thermal expansion of the main body is optionally greater than a second coefficient of thermal expansion of the fixing material. In order to obtain a compression seal, the difference between the first and the second coefficients of thermal expansion in the temperature range of 300 K to 600 K should optionally be at least 3 ppm/K and further optionally at least 5 ppm/K. A third coefficient of thermal expansion of the conductor material of the connecting pin is optionally chosen so as to be roughly equal to or smaller than the second coefficient of thermal expansion of the fixing material. Two coefficients of thermal expansion are considered to be about equal if the difference is less than 3 ppm/K.

As an alternative to a compression seal, the material of the main body, the fixing material and the material of the connecting pin may be chosen such that their respective coefficients of thermal expansion are about equal, wherein a difference of less than 3 ppm/K is considered to be about equal. In this variant, the main body, the connecting pin and the fixing material form a matched metal-fixing material feedthrough.

Optionally, the fixing material has a height, and the main body has a thickness in a region adjacent to the through opening, where the height of the fixing material in a contact region between main body and fixing material is less than the thickness of the main body. Particularly in association with a compression seal, it may be advantageous when the height of the fixing material, in particular referred to a contact region with the main body, is less than the thickness of the main body in this contact region. The fixing material is thus set back with respect to the main body at least on one side of the feedthrough, i.e. there is an offset between fixing material and main body. This measure can prevent or reduce pressure peaks directly at the contact between main body and the fixing material edge. This reduces the risk of material damage to the fixing material. In an advantageous variant, the fixing material may be set back on both sides, i.e. on both sides of the feedthrough, optionally by the same amount.

In such an advantageous embodiment, a surface of the main body adjacent to the through opening protrudes beyond the fixing material on at least one side of the feedthrough. The main body thus forms an excess on one side of the feedthrough or on both sides of the feedthrough.

It may be advantageous when the differential, i.e. the difference, between height of the fixing material and thickness of the main body adds up to not more than 30%, optionally not more than 26% or not more than 24%. An advantageous lower limit for the differential may add up to 10% or 14% or 16%, i.e. the height of the fixing material is, for example, 10% to 30% smaller in total than the thickness of the main body. The differential may be distributed unsymmetrically on the two sides of the feedthrough. It is advantageously distributed symmetrically on the two sides of the feedthrough, such that the fixing material on each side is advantageously set back by at least 5% or at least 7% or at least 8% and/or advantageously by not more than 15% or not more than 13% or not more than 12%. Thus, in an advantageous feedthrough, there may be an offset between main body and fixing material, where the fixing material is set back on each side by 5 to 15%, optionally in each case by 8 to 12%, relative to the main body in the region adjacent to the feedthrough opening.

Optionally, the main body and the connecting pin are formed and arranged in such a way that one end face or both end faces of the connecting pin are arranged flush to a surface of the main body. If the main body has regions with different thicknesses, it is optional that the end face is flush with the surface of the main body adjacent to the through opening. Especially in combination with a fixing material that concludes flush with the surface of the main body, this achieves a flat shape of the electrical feedthrough, and the feedthrough advantageously has a minimum construction height.

Alternatively, one end face or both end faces of the connecting pin may extend beyond a surface of the main body. This creates an elevated contact area, which allows easy electrical contacting of the connecting pin, for example by welding on terminal lugs.

The electrical feedthrough may have exactly one opening with exactly one connecting pin. However, depending on the application of the electrical feedthrough, it is possible to provide several openings in the main body and to pass one connecting pin through each of the openings. It may also be the case that several connecting pins are passed through one opening, in which case these are held by the fixing material and are electrically insulated from each other.

Optionally, the connecting pin of the electrical feedthrough which is provided for an electrical energy storage device has a length in the range of 2 mm to 8 mm, optionally 3 mm to 6 mm. The diameter of the connecting pin is optionally in the range of 1 mm to 20 mm, optionally 2 mm to 10 mm. Optionally, the connecting pin of the electrical feedthrough which is provided as a terminal for an electric compressor or for a connector has a length in the range of 10 mm to 80 mm, optionally 20 mm to 60 mm. The diameter of the connecting pin is optionally in the range of 1 mm to 10 mm, optionally 2 mm to 5 mm.

The connecting pin is optionally of cylindrical shape. It may advantageously have a cylindrical body or take the form of a cylindrical body, such that the connecting pin has one outer face and two end faces. The outer face of the cylinder is directed toward the fixing material. More optionally, the connecting pin has a circular cylinder shape. In addition to the circular cylinder shape, general cylinder shapes with other shapes of the end faces are also conceivable. For example, oval shapes or rectangles with rounded corners are conceivable. In addition, the connecting pin may have, for example, what is called a nail-head shape, which can be formed, for example, by two adjoining cylinders. In this case, a first end face of such a nail-head-shaped connecting pin is formed by a cylinder end face with the larger area and a second end face by a cylinder end face with the smaller area.

The connecting pin is optionally partly or fully covered on at least one end face by an electrically conductive cover material.

The cover material may be applied to the end face of the connecting pin, for example, by plating, galvanizing, coating, vapour deposition, welding or soldering.

Optionally, the cover material is selected from the group including aluminium, an aluminium alloy, AlSiC, copper, a copper alloy, molybdenum, nickel or nickel alloys, palladium, silver and gold.

The thickness or length of the cover material is advantageously 50% to 5%, optionally 40% to 10%, optionally 30 to 20%, of the length of the connecting pin. The thickness or length of the cover material may advantageously be not more than or less than 50%, optionally not more than 45%, optionally not more than 40%, optionally not more than 30%, in some advantageous variants not more than 25% or not more than 20% or not more than 15%. An advantageous lower limit for the thickness or length of the cover material may be at least 5% or at least 10%, optionally at least 20%, in some advantageous variants at least 25%.

If the connecting pin is provided with a cover material on each end face, the cover materials chosen may be identical or different. In particular, in the case of configuration of the electrical feedthrough as cover for an electrical energy storage device or as part of a housing for an electrical energy storage device, it is possible, for example, to choose a material on an inward facing side which is resistant to an electrolyte accommodated in the interior, and to choose a different material such as aluminium or an aluminium alloy on the outside.

The cover material may completely cover the respective end face or even cover only a portion thereof.

The core of the connecting pin optionally takes the form of a sleeve element with a through opening. Such a through opening may in particular have a closable design and may serve, for example, as a filling opening for filling the housing with an electrolyte in the manufacture of an electrical energy storage device.

The connecting pin optionally includes a closure element which closes the through opening in the sleeve element of the connecting pin.

The closure element is optionally connected to the sleeve element at an end face thereof. Alternatively or additionally, the closure element is optionally connected to the sleeve element at a wall of the through opening. Accordingly, the closure element may be designed as a lid and cover the through opening. The closure element may also be designed as a plug, and engage in the through opening. Mixed shapes are also possible here for the closure element.

The closure element, at least at its surface adjacent to the sleeve element, optionally consists of copper, a copper alloy, aluminium or an aluminium alloy. As part of the connecting pin, the closure element may be provided with the cover material at one or both end faces.

It is also conceivable that an intermediate material is disposed on surfaces of the closure element that face the sleeve element and/or on surfaces of the sleeve element that face the closure element. The intermediate material, like the cover material, may be applied to the end face of the sleeve element or of the closure element, for example, by plating, galvanizing, coating, vapour deposition, welding or soldering.

The intermediate material on the closure element or the sleeve element is optionally selected so that it can be bonded efficiently to the other element by welding or soldering. In particular, the intermediate material chosen may be identical to the material of the closure element or the sleeve element. For example, in the case of a closure element made of aluminium, the sleeve element may be provided with aluminium as intermediate material.

The connecting pin may be connected to a terminal pad and/or a terminal lug.

Such a terminal lug may be, for example, a metal sheet or a metal foil which is connected to the connecting pin by welding or soldering. The material of the terminal lug may be identical or different from the material of the connecting pin.

Such a terminal pad is electrically connected to the connecting pin, for example by adhesive bonding, welding or soldering, and provides an enlarged electrical contact face with respect to the end face of the connecting pin. The terminal pad is optionally connected to the main body and/or the fixing material through an electrically insulating material. The material of the terminal pad is optionally selected so as to be identical to the material of the core of the connecting pin or a cover material of the connecting pin.

In order to be able to connect the terminal pad electrically to the connecting pin, these are positioned close to one another. For this purpose, a portion of the connecting pin that projects beyond the through opening in the main body optionally engages in an opening in the terminal pad, wherein said opening in the terminal pad may take the form of a through opening or of a blind hole. In order to enable a good connection between the at least one terminal pad and the connecting pin, it is optional that the connecting pin protrudes at least by 0.1 mm to 2 mm, optionally 0.2 mm to 1 mm, beyond the through opening and hence beyond the main body. Optionally, the at least one terminal pad is secured to the main body in an electrically insulating manner over the whole area using an adhesive or using a cast material as insulation material.

The choice in accordance with the invention of a copper material with a 0.2% yield strength after thermal treatment of at least 150 N/mm² allows the connecting pin of the electrical feedthrough also to be heated several times without the electrical feedthrough becoming leaky. For example, an electrical feedthrough having a through opening in the connecting pin can be heated for a first time in order to connect an electrode of a battery or a capacitor to an inward-facing side, for a second time in order to close the through opening with a closure element, and for a third time in order to connect a terminal lug or terminal pad to the connecting pin on an outward-facing side. The electrical feedthrough according to the invention is sealed, in particular hermetically sealed, even after such repeated uneven heating.

In order to avoid a fracture in the fixing material, i.e. the glass or glass-ceramic material, in particular after the sealing, for example owing to thermal effects, it may be advantageous when the main body includes a flexible flange for joining the main body to further components such as constituents of a housing. The flange itself includes a region, called a connection region, by which a further component is connected to the main body. The connection to the main body can be effected by welding, in particular ultrasonic welding or soldering. The weld bond is optionally designed such that the connection is largely gas-tight, and a He leakage rate of less than 10⁻⁸ mbar l/sec at a pressure differential of 1 bar is optionally provided.

The flexible flange can be obtained very easily. For example, the main body may be designed as a sheet metal part with a thickness d₂ which is stamped down to thickness d₁, and, after the stamping, the section with thickness d₁ is deformed such that the flexible flange is formed. It may be the case here that the original thickness d₂ is retained around the region of the opening, such that the region adjacent to the opening is reinforced. It is also possible that a metal sheet with a thickness d₁ is formed to a flexible flange, and the raised metal sheet or a collar formed by forming the metal sheet accommodates the seal. A seal into a raised flexible flange, in particular to a collar of the flexible flange, is possible especially when the flexible flange and the raised region includes austenitic steel or duplex steel as material.

In an advantageous embodiment, a relief device may be provided in the main body instead of or in addition to a flexible flange. The relief device advantageously includes at least one groove or depression, optionally at least one circumferential groove or circumferential depression. Instead of one groove, it is also possible to provide a series of adjacent recesses.

The relief device can reduce a thermal flow through the main body, i.e. create a thermal barrier, and/or reduce mechanical load on the main body perpendicular to the axis of the connecting pin, since the main body is deformable, optionally reversibly deformable, in the direction perpendicular to the axis of the connecting pin. This has the effect that fewer stresses are introduced into the fixing material, in particular no tensile stresses that act on the fixing material and hence reduce compression on the fixing material, which improves the leaktightness of the feedthrough under thermal and mechanical loads.

In an advantageous first variant, the relief device, in particular groove or depression, is positioned on the first side of the electrical feedthrough which faces outward when a housing is formed. In an advantageous alternative second variant, the relief device, in particular groove or depression, is positioned on the second side of the electrical feedthrough which faces inward when a housing is formed. In a particularly advantageous third variant, the relief device includes at least two grooves or recesses positioned on opposite sides of the main body.

The electrical feedthroughs described herein are particularly suitable for use for housings of electrical energy storage devices, for use in electrical connectors, and for use in housings for electrically driven compressors.

Accordingly, a further aspect of the invention is that of providing an electrical storage device, in particular a battery or a capacitor, which includes a housing with at least one of the electrical feedthroughs described herein.

In this case, the main body is designed in particular as a housing part for forming a housing for an electrical storage device. For example, the main body may take the form of a lid part which can be joined together with a cup-shaped housing part to form a housing for an electrical storage device. However, the main body may also be a constituent of a lid or lid part in that it is inserted into an opening formed in a lid element. The electrical storage device may in particular be a battery or a capacitor, including a supercapacitor, wherein the housing typically accommodates one or more storage cells and can be electrically contacted from the outside via the electrical feedthrough as connection terminal. The feedthrough may also take the form of a multipole feedthrough in which the main body has several through openings, and a connecting pin is held via a fixing material in each of the through openings.

It is customary to provide a safety valve and/or a predetermined break point as a safety element in housings for an energy storage device, in order to achieve controlled release of excess pressure therein. The electrical feedthrough optionally has such a safety element. For this purpose, it is optional to choose an expulsion force for the connecting pin held by the fixing material such that the connecting pin is pushed out when a predetermined expulsion force is exceeded. Such adjustment of the expulsion force is known, for example, from DE 2020 20106 518 U1.

Optionally, the fixing material and its connection to the wall of the through opening and the connecting pin is designed such that a safety valve function is provided via a predetermined expulsion force, wherein the predetermined expulsion force is adjusted by one or more of the following measures:
a. selecting the thickness of the seal,
b. selecting the fixing material,
c. selecting the bubble fraction in the fixing material,
d. structuring the surface of the fixing material by adjusting the shape of a fixing material body prior to sealing,
e. structuring the surface of the fixing material during sealing,
f. laser processing the surface of the fixing material after sealing,
g. inserting notches or tapers into one or both sides of the fixing material, and/or
h. inserting notches or tapers into the connecting pin and/or the main body.

The present invention also provides an electrically driven compressor including a housing with at least one of the electrical feedthroughs described herein. The electrical feedthrough is designed here, for example, as a connection terminal and optionally has an elongated main body in sheet form. The main body optionally includes several openings, through each of which a connecting pin in the form of an electrical conductor is passed.

The present invention also provides an electrical connector having at least one of the electrical feedthroughs described herein.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an example of an electrical feedthrough with a single connecting pin;

FIG. 2 is an example of an electrical feedthrough with three connecting pins passed through;

FIG. 3 is an example of an electrical feedthrough with a connecting pin clad on one side;

FIG. 4 is an example of an electrical feedthrough with a connecting pin clad on both sides;

FIG. 5 is an example of an electrical feedthrough with a connecting pin clad on both sides, which extends beyond the main body;

FIG. 6 is an example of an electrical feedthrough with a connecting pin with a through opening;

FIG. 7 is an example of an electrical feedthrough with a connecting pin with a through opening and a closure element;

FIG. 8 is an example of an electrical feedthrough with a connecting pin with a closure element clad on one side;

FIG. 9 is an example of an electrical feedthrough with a connecting pin with a closure element clad on both sides;

FIG. 10 is an example of an electrical feedthrough with a terminal pad connected to the connecting pin;

FIG. 11 is an example of an electrical feedthrough with a connecting pin clad on one side and contact lug connected to the connecting pin;

FIG. 12 is an example of an electrical feedthrough with a lid-shaped closure element;

FIG. 13 is a further example of an electrical feedthrough with a connecting pin with a through opening;

FIG. 14 is a second example of an electrical feedthrough with a closure element in lid form;

FIG. 15 is an example of an electrical feedthrough with a main body having a flexible flange; and

FIG. 16 is an example of an electrical feedthrough with a main body having a relief device.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

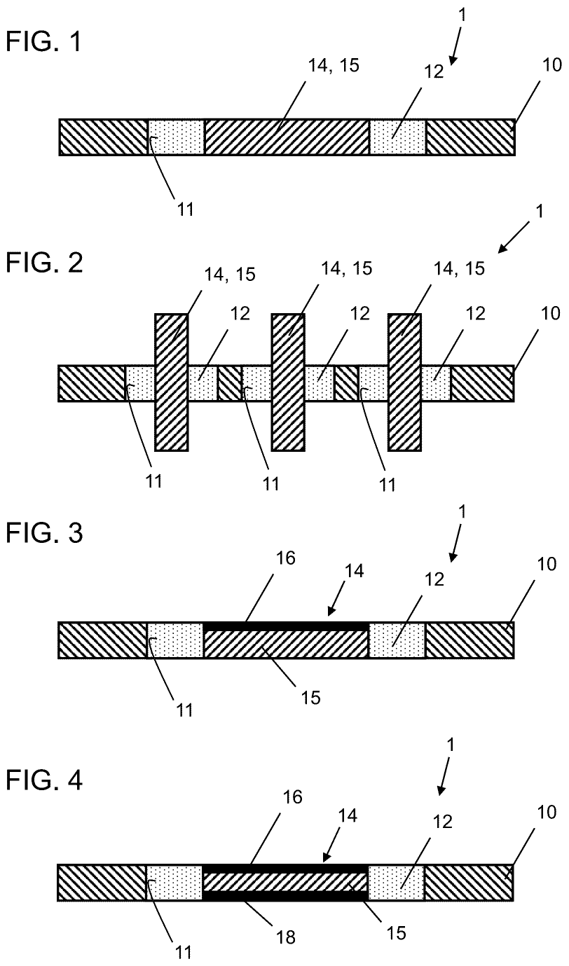

FIG. 1 shows a schematic of a first working example of an electrical feedthrough 1. The electrical feedthrough 1 includes a main body 10 with an opening 11. A connecting pin 14 is passed through the opening 11 and consists here of a solid one-piece core 15 and is held in the opening 11 by way of a fixing material 12. The fixing material 12 provides sealing both against a wall of the opening 11 and against the connecting pin 14, such that the opening 11 is sealed by the fixing material 12. The fixing material 12, which is a glass material, glass-ceramic material or ceramic material, is melted onto the surfaces of the opening 11 of the main body 10 and of the connecting pin 14. For this purpose, a base assembly composed of the main body 10, a fixing material blank and connecting pin 14 was subjected to a thermal treatment in an oven in which the base assembly is subjected to a temperature above the melting temperature of the fixing material, where the melting temperature is typically above 500° C. or even above 600° C.

In the first working example shown in FIG. 1, the connecting pin 14 is in one-piece and solid form and consists of a copper material which, after the thermal treatment for joining the fixing material, has a 0.2% yield strength of at least 150 N/mm². The material thus selected for the connecting pin 14 is resistant to plastic deformation even after thermal treatment. This is advantageous especially when the electrical feedthrough 1 is heated unevenly in that the connecting pin 14 is heated, while the fixing material 12 and the main body 10 remain at lower temperature. This can occur, for example, on soldering or welding of electrical contacts to the connecting pin 14. The heating of the connecting pin 14 causes it to expand, with the unheated fixing material 12 exerting pressure on the connecting pin 14. When a material with a 0.2% yield strength below 150 N/mm² is used, these compressive forces lead to plastic deformation of the connecting pin 14. After subsequent cooling of the connecting pin 14, in which the material contracts again, deformation of the connecting pin 14 may result in gaps between the fixing material 12 and connecting pin 14, causing the electrical feedthrough to leak. When materials are chosen in accordance with the invention, there is no plastic deformation when the connecting pin 14 is heated, and so the electrical feedthrough 1 remains sealed after cooling.

In the first working example, the connecting pin 14 is flush with the main body 10 and the fixing material 12. In other embodiments, the connecting pin 14 can also extend beyond the main body 14 on one or both sides. The fixing material 12 may be set back relative to the main body 10. If the connecting pin 14 extends beyond the main body 10, the fixing material may also partly extend beyond the main body 10.

FIG. 2 shows a second working example of an electrical feedthrough 1, in which the main body 10 has multiple openings 11. A connecting pin 14 is conducted through each of the openings 11, and consists here of a core 15 in the form of an elongated electrical conductor. The core consists of a copper material, as described with reference to FIG. 1. The connecting pins 14 are each held in place in the opening 11 by way of the fixing material 12, where the fixing material 12 seals the respective opening 11. In the example shown in FIG. 2, the electrical feedthrough 1 has three connecting pins 14 that have been passed through. Of course, the number of connecting pins can be adjusted according to the required number of electrical contacts, such that, for example, 2 or 5 connecting pins 14 may also be passed through.

The second working example shown in FIG. 2 is suitable in particular for use as a connection terminal for an electrically driven compressor.

FIG. 3 shows a third working example of an electrical feedthrough 1. The third working example corresponds to the first working example described with reference to FIG. 1, except that the connecting pin 14 has a core 15 covered by a cover material 16 at one of its end faces. The cover material 16 is different from the copper material of the core 15. For example, the cover material 16 may be selected in order to ensure good solderability or weldability to an electrical terminal. For example, aluminium or an aluminium alloy is selected as cover material 16.

FIG. 4 shows a fourth working example of an electrical feedthrough 1. The fourth working example corresponds to the third working example described with reference to FIG. 3, except that the connecting pin 14 has a core 15 covered by the cover material 16 at a first end face and covered by a further cover material 18 at a second end face. The cover material 16 and the further cover material 18 are different from the copper material of the core. The further cover material 18 may be selected, for example, in order to ensure good solderability or weldability to an electrical terminal. In the case of a configuration of the electrical feedthrough 1 as a battery cover or part of a battery cover, the further cover material may also be selected such that it has a particularly high resistance to an electrolyte accommodated in the battery. For example, aluminium or an aluminium alloy is selected as a further cover material 18.

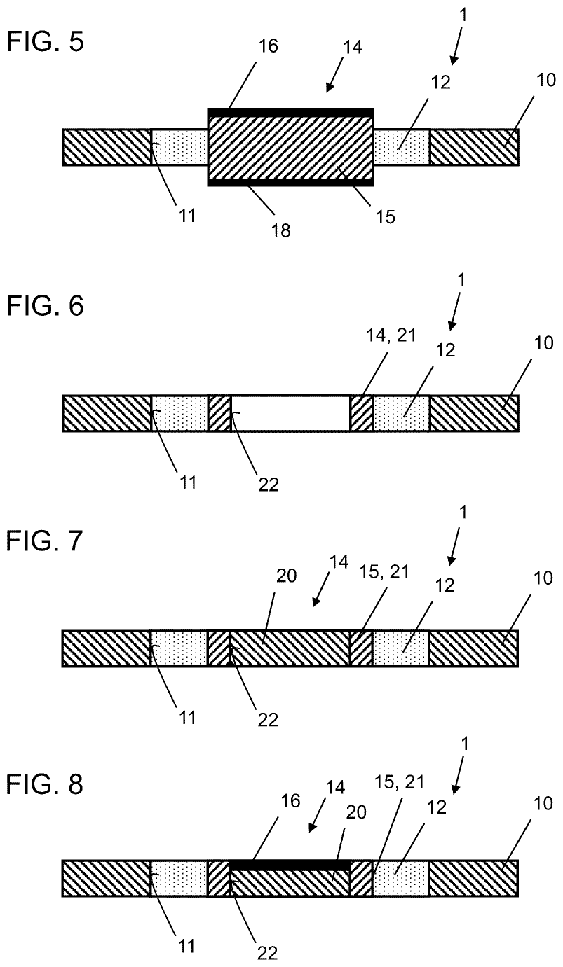

FIG. 5 shows a fifth working example of an electrical feedthrough 1. The fifth working example corresponds to the fourth working example described with reference to FIG. 4, except that the core 15 of the connecting pin 14 is not executed so as to be flush with the main body 10, but protrudes beyond the surfaces of the main body 10 on both sides of the electrical feedthrough 1.

FIG. 6 shows a sixth working example of an electrical feedthrough 1. The electrical feedthrough 1 includes a main body 10 with an opening 11. A connecting pin 14 is passed through the opening 11 and consists here of a one-piece core 15 which is in the form of a sleeve element 21 and has a through opening 22. The connecting pin 14 is inserted into the opening 11 of the main body 10 and held in place by way of a fixing material 12. The fixing material 12 provides sealing both against a wall of the opening 11 and against the connecting pin 14, such that the opening 11 is sealed by the fixing material 12. The through opening 22 remains open here, although this can later be closed by way of a closure element 20 (compare FIG. 7).

When the electrical feedthrough 1 takes the form of a battery cover or part of a battery cover, the through opening 22 can serve, for example, as a filling opening in order to fill the battery with an electrolyte.

FIG. 7 shows a seventh working example of an electrical feedthrough 1. The seventh working example corresponds to the sixth working example described with reference to FIG. 6, but the through opening 22 in the core 15 that takes the form of a sleeve element 21 is not open here. The connecting pin 14 here additionally has a closure element 20 which seals the through opening 22.

In the example of FIG. 7, the closure element 20 is in one-piece and solid form and may consist of a copper material like the core 15. The copper material may be identical to the copper material of the core. Alternatively, another copper material or a different material such as aluminium or an aluminium alloy may be chosen. The closure element is formed here similarly to a plug and is secured to a wall of the through opening 22, for example by welding, soldering or adhesive bonding.

FIG. 8 shows an eighth working example of an electrical feedthrough 1, which largely corresponds to the seventh working example described with reference to FIG. 7. In the working example of FIG. 8, the closure element 20 additionally includes a cover material 16 positioned on one of the end faces. The cover material 16 chosen is different from the material of the closure element 20. For example, the cover material 16 may be selected in order to ensure good solderability or weldability to an electrical terminal. For example, aluminium or an aluminium alloy is selected as cover material 16, and a copper material is chosen as material for the closure element 20.

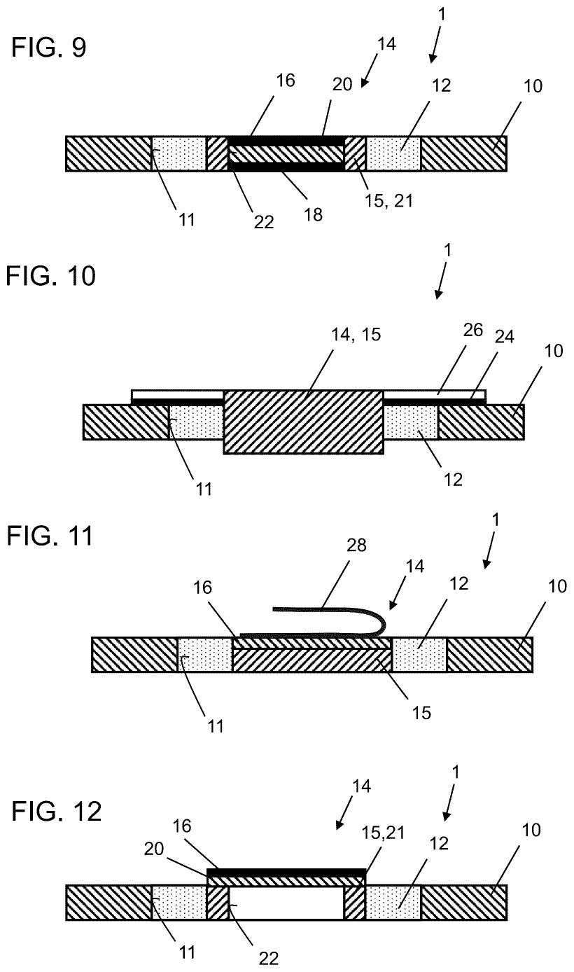

FIG. 9 shows a ninth working example of an electrical feedthrough 1, which largely corresponds to the eighth working example described with reference to FIG. 8. However, the closure element 20 is covered at both end faces and has the cover material 16 on a first end face and the further cover material 18 on a second end face. The cover materials 16, 18 chosen may be identical or different. In particular, the further cover material 18 may be selected such that it is resistant to the media present in the battery, in particular to the electrolyte, in the case of configuration of the electrical feedthrough 1 as a battery cover or as part of a battery housing.

FIG. 10 shows, in a schematic representation, a tenth working example of an electrical feedthrough 1.

The electrical feedthrough 1 includes a main body 10 with an opening 11. A connecting pin 14 is passed through the opening 11, and consists here, as in the first embodiment, of a solid one-piece core 15 and is held in the opening 11 by way of a fixing material 12. The fixing material 12 provides sealing both against a wall of the opening 11 and against the connecting pin 14, such that the opening 11 is sealed by the fixing material 12. The fixing material 12, which is a glass material, glass-ceramic material or ceramic material, is melted onto the surfaces of the opening 11 of the main body 10 and of the connecting pin 14.

The connecting pin 14, in the example shown in FIG. 10, protrudes beyond the main body 10 on both sides, where the fixing material 12 is formed flush with the main body 10. There is additionally a terminal pad 26 on a first side which faces outward, for example, when the electrical feedthrough 1 is used as a battery cover or part of a battery cover. This is connected in an electrically conductive manner to the connecting pin 14 and is additionally held in place against the fixing material 12 and the main body 10 by way of an insulator 24. For example, the insulator 24 may be an adhesive. The terminal pad 26 and connecting pin 14 can be connected, for example, via soldering or welding, in particular via laser welding. The terminal pad 26 may consist of the same material as the connecting pin 14, but it is alternatively also possible to select a different material. The terminal pad 25 advantageously increases an area available for electrical contacting.

FIG. 11 shows a schematic of an eleventh working example of an electrical feedthrough 1, which largely corresponds to the eighth working example described with reference to FIG. 8. In addition, the electrical feedthrough 1 here has a terminal lug 28 connected to the cover material 16 of the connecting pin 14, for example by soldering or welding. The chosen material of the terminal lug 28 is optionally identical to the cover material 16. The terminal lug 28 facilitates electrical contacting of the electrical feedthrough 1.

FIG. 12 shows a twelfth working example of an electrical feedthrough 1. The twelfth working example corresponds to the sixth working example described with reference to FIG. 6, but the through opening 22 in the core 15 that takes the form of a sleeve element 21 is not open here. The connecting pin 14 here additionally has a closure element 20 which seals the through opening 22. In contrast to the seventh working example of FIG. 7, the closure element 20 here takes the form of a lid and does not engage in the through opening 22 of the core 15 in the form of a sleeve element 21. The closure element 20 in lid form is connected to the sleeve element 21 only at an end face thereof, for example by welding or soldering.

The closure element 20 additionally includes a cover material 16 which is chosen so as to be different from the material of the closure element 20. The material of the closure element is optionally a copper material, which may be identical to the copper material of the core 15. The cover material 16 is, for example, aluminium or an aluminium alloy.

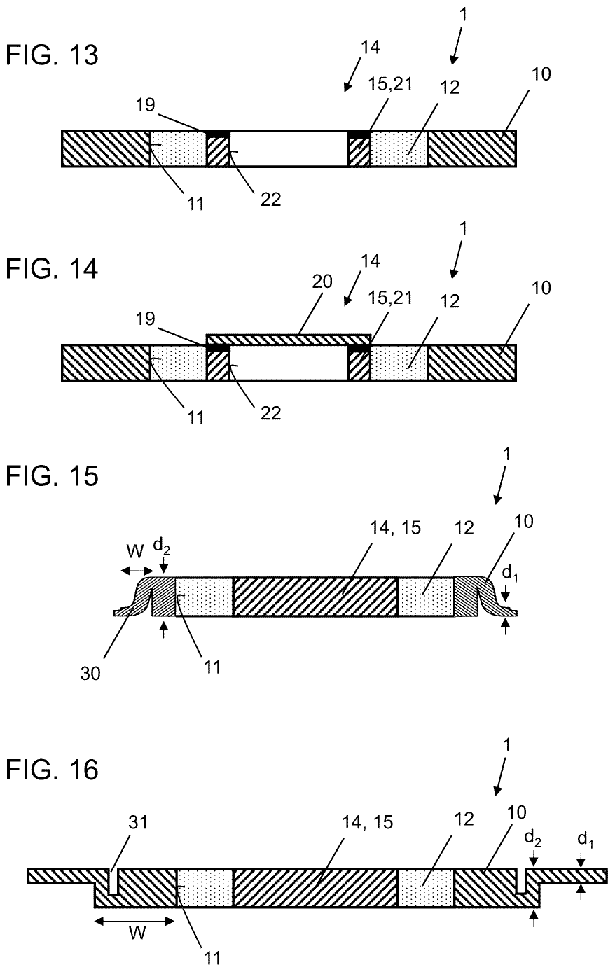

FIG. 13 shows a schematic of a thirteenth working example of an electrical feedthrough 1. The thirteenth working example is similar to the sixth working example described with reference to FIG. 6. In contrast thereto, the core 15 is provided with an intermediate material 19 on one of its end faces, for example by coating or cladding. The intermediate material 19 is chosen so as to be different from the material of the core 15 and may, for example, be aluminium or an aluminium alloy. In a further variant, the core 15 may also be provided with an intermediate material 19 on both end faces.

FIG. 14 shows a schematic of a fourteenth working example for an electrical feedthrough 1. The fourteenth working example largely corresponds to the thirteenth working example described with reference to FIG. 13. However, the connecting pin 14 here additionally has a closure element 20. The core 15 has the intermediate material 19 on its end face facing the closure element 20. The materials for the closure element 20 and the intermediate material 19 are optionally both selected from aluminium and aluminium alloys, and so they can be efficiently connected to each other by welding or soldering.

In addition to the variants of the closure element 20 shown in FIGS. 7 and 8 and FIGS. 12 and 14, further configurations are also conceivable. For example, the plug-like configuration of FIGS. 7 and 8 can be combined with the lid-like configuration of FIGS. 12 and 14, such that the closure element 20 adjoins the sleeve element 21 both at an end face and at the wall of the through opening 22.

FIG. 15 shows a further working example of an electrical feedthrough 1 which is of similar design as the first working example of FIG. 1, except that the main body 10 additionally includes a flexible flange 30 via which the main body 10 can be connected to further elements, for example to further constituents of a housing. The flexible flange 30 is obtained, for example, by forming the main body 10 and has a transition region with a width W within which a flat section of the main body 10 merges into a sealing section with a thickness d₂ greater than the thickness d₁ of the flat section of the main body 10. The main body 10 is flexible and pliant in the transition region, such that the flexible flange 30 mechanically decouples the region with the opening 11. Accordingly, mechanical stresses from other parts of the housing are not transmitted to the fixing material 12. In addition, the thickness d₂ may be chosen freely within a wide range within the sealing section, such that a sealing length can be set independently of other dimensions of the main body 10 or of a housing including the main body 10.

FIG. 16 shows an electrical feedthrough 1 in which a relief device is provided in the main body 10, in the form here by way of example of a recess or groove 31, optionally of a circumferential groove or circumferential depression.

The main body 10 has a reinforcing region with a width W that adjoins the opening 11 and within which the main body 10 has an elevated thickness d₂. Outside the reinforcement region, the main body 10 has the lower thickness d₁.

In the example shown in FIG. 16, the groove 31 of the relief device is positioned by way of example on the side of the electrical feedthrough 1 that faces outward when a housing is formed. Of course, it could also be positioned on the other side of the housing. It is also possible for two grooves 31 or recesses positioned on opposite sides of the main body 10 to serve as relief device. Instead of one groove 31, it is also possible to provide a series of adjacent recesses.

The relief device reduces a thermal flow through the main body 10, i.e. creates a thermal barrier, and/or reduces mechanical load on the main body 10 perpendicular to the axis of the connecting pin 14, since the main body 10 is deformable, optionally reversibly deformable, in the direction perpendicular to the axis of the connecting pin 14. This has the effect that fewer stresses are introduced into the fixing material 12, in particular no tensile stresses that act on the fixing material 12 and hence reduce compression on the fixing material 12, which ensures leaktightness of the feedthrough 1 under thermal and mechanical loads.

The embodiments of the main body 10 shown in FIGS. 15 and 16 can be applied in particular to the variants of the electrical feedthrough 1 shown in FIGS. 2 to 14.

Although the present invention has been described with reference to optional working examples, it is not limited thereto, and is modifiable in various ways.

### LIST OF REFERENCE NUMERALS

1 electrical feedthrough
10 main body
11 opening
12 fixing material
14 connecting pin
15 core
16 cover material
18 further cover material
19 intermediate material
20 closure element
21 sleeve element
22 through opening
24 insulator
26 terminal pad
28 terminal lug
30 flexible flange
31 groove

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical feedthrough, comprising:
a fixing material;
a main body including an opening; and
a connecting pin, which is passed through the opening in the main body and which is held in place by the fixing material which seals the opening, the fixing material being a glass material, glass-ceramic material, or a ceramic, the connecting pin including or consisting of a core, the core directly adjoining the fixing material and including a copper material, the copper material in an annealed state after forming the electrical feedthrough having a 0.2% yield strength of at least 150 N/mm².

2. The electrical feedthrough according to claim 1, wherein the copper material is (a) a dispersion-hardened copper material or (b) a copper alloy which is selected from Cu—Al₂O₃, CuBe, CuCoNiBe, CuCr, CuZr, CuNiSi, and CuNiSiCr.

3. The electrical feedthrough according to claim 1, wherein the copper material includes (a) at least 95% by weight of copper and (b) at least one of (i) at least 0.1% by weight of Al₂O₃ and (ii) at least 0.03% by weight of boron.

4. The electrical feedthrough according to claim 1, wherein the connecting pin includes an end face, wherein the connecting pin is partly or completely covered on at least one said end face with a cover material that is electrically conductive.

5. The electrical feedthrough according to claim 4, wherein the cover material has been applied to the end face of the connecting pin by cladding, electroplating, coating, vapor deposition, welding, or soldering.

6. The electrical feedthrough according to claim 4, wherein the cover material is selected from aluminum, an aluminum alloy, AlSiC, copper, a copper alloy, molybdenum, nickel or nickel alloys, palladium, and silver or gold.

7. The electrical feedthrough according to claim 4, wherein the core of the connecting pin is formed as a sleeve element with a through-opening.

8. The electrical feedthrough according to claim 7, wherein the connecting pin includes a closure element which closes the through-opening in the sleeve element of the connecting pin.

9. The electrical feedthrough according to claim 8, wherein at least one of:
(a) the sleeve element includes an end face, the closure element being connected to the sleeve element on the end face of the sleeve element; and
(b) the through-opening of the sleeve element includes a wall, the closure element being connected to the wall of the through-opening of the sleeve element.

10. The electrical feedthrough according to claim 8, wherein the closure element includes a surface adjacent to the sleeve element, wherein the closure element includes copper, a copper alloy, aluminum, or an aluminum alloy at least on the surface adjacent to the sleeve element.

11. The electrical feedthrough according to claim 1, wherein a first coefficient of expansion of the main body is greater than a second coefficient of expansion of the fixing material.

12. The electrical feedthrough according to claim 11, wherein a difference between the first coefficient of expansion and the second coefficient of expansion is greater than 3 ppm/K.

13. The electrical feedthrough according to claim 1, wherein the electrical feedthrough is configured for being a part of an electrical connector.

14. An electrical storage device, comprising:
a housing including an electrical feedthrough, which includes:
a fixing material;
a main body including an opening; and
a connecting pin, which is passed through the opening in the main body and which is held in place by the fixing material which seals the opening, the fixing material being a glass material, glass-ceramic material, or a ceramic, the connecting pin including or consisting of a core, the core directly adjoining the fixing material and including a copper material, the copper material in an annealed state after forming the electrical feedthrough having a 0.2% yield strength of at least 150 N/mm².

15. The electrical storage device according to claim 14, wherein the electrical storage device is a battery or a capacitor.

16. An electrically-driven compressor, comprising:
a housing including an electrical feedthrough, which includes:
a fixing material;
a main body including an opening; and
a connecting pin, which is passed through the opening in the main body and which is held in place by the fixing material which seals the opening, the fixing material being a glass material, glass-ceramic material, or a ceramic, the connecting pin including or consisting of a core, the core directly adjoining the fixing material and including a copper material, the copper material in an annealed state after forming the electrical feedthrough having a 0.2% yield strength of at least 150 N/mm².
